(19) United States
(12) Patent Application Publication
(10) Pub. No.: US 2005/0115511 A1
(43) Pub. Date: Jun. 2, 2005

(54) Folding pack for absorbent material for a cat lavatory

(76) Inventor: Dietmar Lange, Vallendar (DE)

Correspondence Address: FULBRIGHT & JAWORSKI, LLP, 1301 MCKINNEY, SUITE 5100, HOUSTON, TX, 77010-3095, US

(21) Appl. No.: 10/505,710

(22) PCT Filed: Feb. 26, 2003
(86) PCT No.: PCT/EP03/01960

(30) Foreign Application Priority Data
Feb. 28, 2002 (DE) 102087237

(51) Int. Cl. A01K 29/00

(52) U.S. Cl. 119/169; 119/165

(57) ABSTRACT

A folding pack for absorbent material for use in a cat lavatory, and a cat lavatory equipped therewith, which forms a dimensionally stable container pack that can be unfolded for use and placed in a cat lavatory.

### CROSS-REFERENCE TO RELATED APPLICATIONS

This application is a national stage of PCT/EP03/01960 filed on Feb. 26, 2003 claiming priority to DE 10208723.7 filed on Feb. 29, 2002.

### TECHNICAL FIELD

The invention relates to a folding pack for absorbent material for use in a cat lavatory, and a cat lavatory equipped therewith.

### BACKGROUND OF THE INVENTION

It is a well-known fact that cats can easily be trained to deposit their urine and feces in a container provided for that purpose. In a simple embodiment, this container is filled with a porous, absorbent and preferably odor-inhibiting material known as cat litter. The cat litter has to be replaced regularly. Cleaning a cat lavatory of this kind is an onerous and unpleasant task, however, since it is possible for the lavatory walls to be soiled or for there to be litter adhering to the lavatory walls. In addition, large quantities of litter have to be disposed of each time, since the litter ought to be 6 to 8 cms deep on average, which means that the litter consumption is as a rule greater than would otherwise be necessary. Furthermore, simply tipping the cat litter into a dustbin or the like is also unhygienic, and, what is more, annoying dust and odor problems are unavoidable in the process.

Cat lavatories are known in the state of the art in which a resealable bag filled with cat litter can be placed in the cat lavatory container. That bag can be sealed after use and disposed of simply with the household refuse.

DE 31 17 900 A1, for example, teaches a container for holding litter material, in which are provided an inner bag and an outer bag surrounding said inner bag, wherein said inner bag consists of a folding blank having radial folds. In this solution, the outer bag is necessary in order to prevent the litter material from urging the folds of the inner bag apart and deforming it, so that the outer bag determines the shape of the inner bag. A disadvantage here is that a separate outer bag is needed as separate packaging, the purpose of which merely consists in preventing any unwanted deformation of the filled inner container.

The object of the invention consists in improving the known container and a cat lavatory equipped therewith such that the disadvantages described no longer occur and a folding pack is provided which is inexpensive to manufacture and easy to handle.

### BRIEF SUMMARY OF THE INVENTION

This object is achieved in accordance with the invention by a folding pack for absorbent material for use in a cat lavatory which forms a dimensionally stable container pack that can be unfolded for use and placed in a cat lavatory.

The folding pack can be stackable and can be substantially block-shaped. The folding pack can conveniently be made from a blank of paper, pasteboard, paperboard, cardboard, light-weight plastic, a composite material or an absorbent material which is flat in its initial state.

The folding pack preferably has a central, preferably substantially rectangular, floor portion, with preferably rectangular wall portions adjoining said floor portion.

It is convenient for corner portions to be provided between adjacent wall portions, with the possibility of said corner portions lying against said wall portions in the folded-up state, such that a substantially block-shaped space for holding absorbent material is formed.

There are preferably lid portions adjoining wall or corner portions. Lid portions will preferably adjoin both the wall portions and the corner portions, such that, when the folding pack is in the folded-up state, there are several of the lid portions lying overlapping on top of one another. It is convenient for the lid portions to be substantially rectangular.

In a preferred further embodiment of the invention, it is provided for there to be handle portions adjacent to the lid portions. The handle portions may lie flat on the lid portions or they may be designed to fold out away from them. It can further be provided for the handle portions to be designed to overlap several times, e.g. four, six or eight times, and thus to form a supporting handle for the folding pack with no tendency to tear off prematurely.

The absorbent material provided may be litter or even a layer of non-woven material, or both. The layer of non-woven material may comprise a highly absorbent and in particular odor binding material and may be joined to or integrated in the material of the folding pack. The layer of non-woven material may be between 0.1 and 1 cm thick, preferably 0.5 cm.

It can be provided for a layer of litter to be disposed on the layer of non-woven material. There will preferably be a sufficient quantity of litter material present in the folding pack to ensure that, when the folding pack is in the unfolded state and has been placed in a cat lavatory, the layer of litter is between 1 and 3 cms deep, preferably 2 cms, namely within a useful interior surface area of the cat lavatory, which will as a rule be (considerably) larger than the area of the floor portion of the folding pack. In this context, it will preferably be provided for the folding pack to be sufficiently deep and to have a sufficient volume to ensure that it is completely filled with litter, in order to achieve a layer of litter 2 cms deep, for example, when the folding pack is in the unfolded state and has been placed in a cat lavatory.

It is convenient for there to be at least one closure means present in order to re-seal the folding pack after use. Adhesive tape or a string my be provided for this purpose. The string (or an elastic tape or the like) may, for example, engage through holes disposed in the edge portion of the folding pack.

The object of the invention is further achieved by a cat lavatory with a tray-shaped lower part and an insert comprising an unfolded folding pack according to the invention. It will preferably be provided for the folding pack to be capable of being unfolded in such a way that, after it has been inserted into the lower part, its outer edge portion can be folded over an upper peripheral rim of the lower part. In the process, said edge portion of the folding pack can be attachable to the upper peripheral rim of the cat lavatory. For this purpose, an upper part may be provided which can be removably placed on the lower part in order to secure the folded-over edge portion of the folding pack on the upper peripheral rim of the lower part. The upper part may be designed in the form of a frame adapted to the shape of the lower part.

### BRIEF DESCRIPTION OF THE DRAWINGS

The invention will now be described on the basis of a working embodiment with reference to a drawing, in which

FIG. 1 shows a perspective view of a folding pack according to the invention in the folded state,

FIG. 2 shows the folding pack of FIG. 1 in a partially unfolded or opened state,

FIG. 3 shows the folding pack in a further unfolded state,

FIG. 4 shows the folding pack in a substantially fully unfolded state and placed in a tray-shaped lower part of a cat lavatory, and

FIG. 5 shows a blank with folding lines for a folding pack in accordance with the invention.

### DETAILED DESCRIPTION OF THE INVENTION

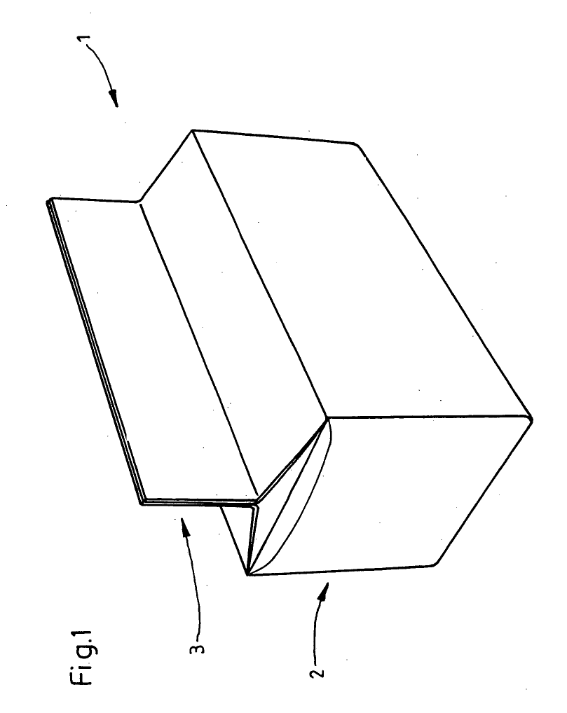

FIG. 1 shows a folding pack, designated as a whole by reference numeral 1, in the folded state in which it forms a dimensionally stable pack container which can be distributed in this form as a sales unit. The folding pack 1 has a substantially block-shaped pack body 2 with a handle portion 3 projecting upwards, the handle portion 3 being capable of being folded down horizontally for the purpose of stacking two or more folding packs 1 on top of one another. The folding pack 1 is produced, in a way that will be explained later, by folding a blank made of a suitable material, which may be paper, paperboard, cardboard, pasteboard, plastic, an absorbent material or a composite material (e.g. varnished or plastic-coated board).

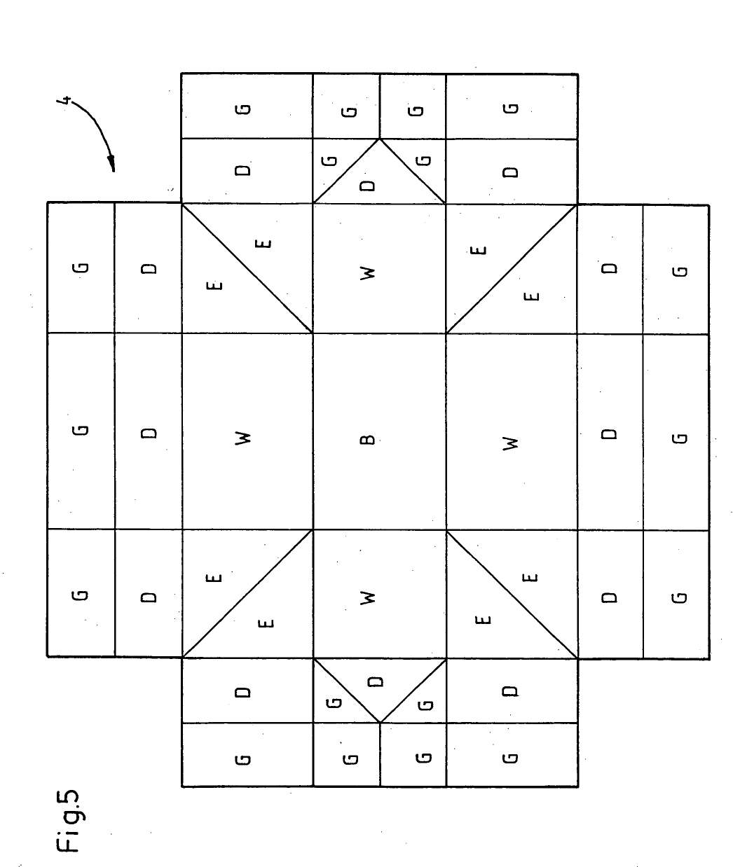

In order to explain the production of the folding pack by folding a blank of material, reference will be made in the following to FIG. 5, in which a blank 4 made from a suitable material is shown. Within the area of the blank 4 are formed a central floor portion B, with wall portions W adjacent to it and corner portions E between adjacent wall portions W. Adjoining said wall and corner portions on the outside is a lid portion D, which in turn has handle portions G adjacent to it. Between the portions mentioned there are fold lines in each case, which are indicated by continuous lines in FIG. 5.

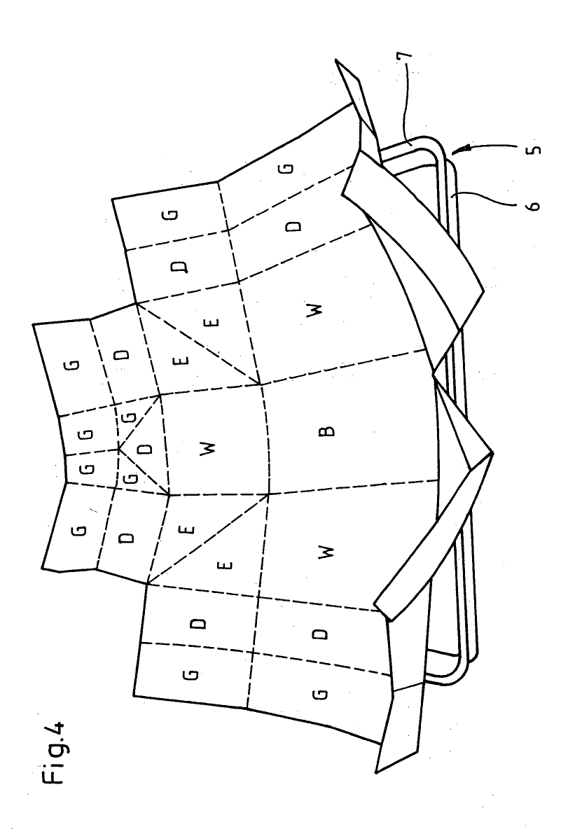

FIG. 4 shows a perspective view of a blank 4 according to the invention or, to be precise, an opened folding pack 1, where the alignment has been rotated by 90° compared to FIG. 5. The opened folding pack is placed on a pan or tray-shaped lower part 5 of a cat lavatory, it being possible for each of the four parts of the folding pack extending to the side and each comprising lid and handle portions D, G to be folded over a rim 7 of the lower part 5, in order to attach it to the lower part to a certain extent. It can be provided for the base area of the lower part 5 to correspond approximately to the area formed by the floor, wall and corner portions B, W, E of the folding pack, which in this embodiment is rectangular, so that the parts extending to the side and each consisting of lid and handle portions first run upwards along the inner side walls 6 of the lower part and can then be folded out sideways and down over the rim 7. A design of this kind is particularly appropriate in connection with a frame-like upper part of the cat lavatory, which can be removably placed on the lower part 5 in such a manner that it passes over the side walls or the rim 7 together with the portions D, G of the folding pack 1 which have been folded over it.

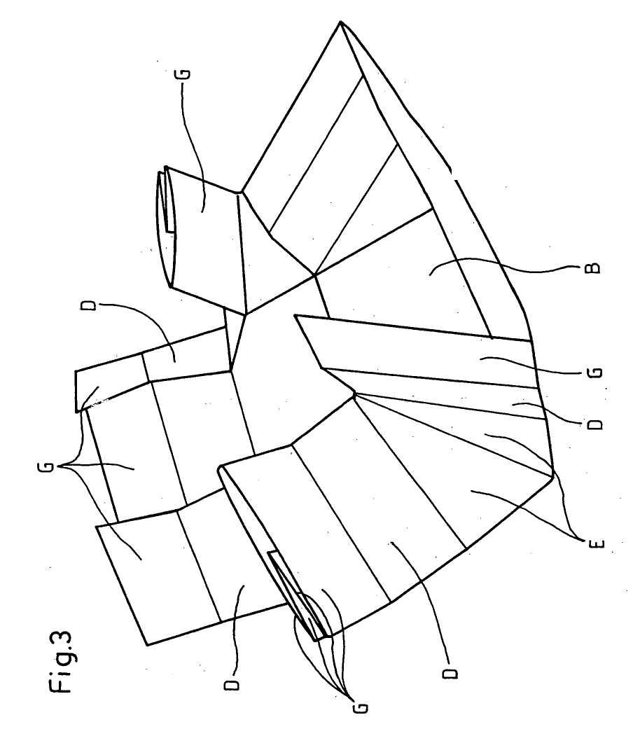

FIG. 3 shows the folding pack in an alignment rotated by about 45° compared to FIG. 4 and in a partially folded (or partially opened) state, in which not only the floor portion B, but also in particular the triangular corner portions E and the lid and handle portions D, G can be seen.

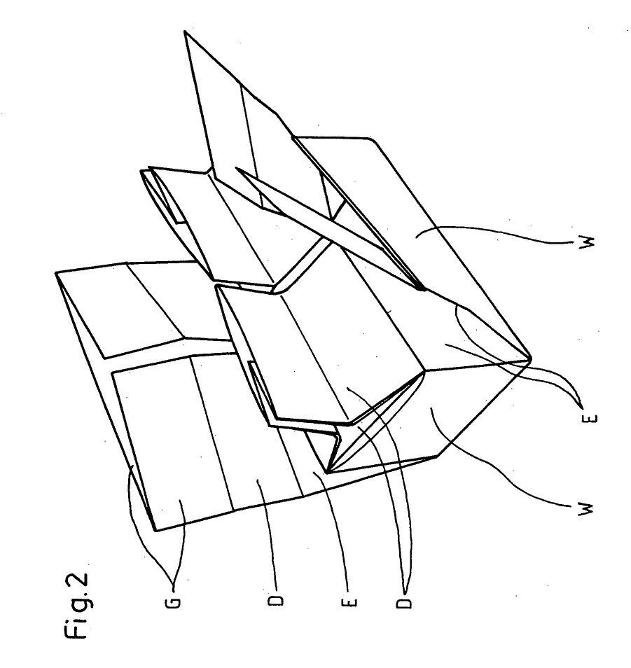

FIG. 2 shows a view corresponding to FIG. 3 in an even further folded state, which now also shows the walls W. As will be seen, the folded corner portions E lie against the walls W, so that a substantially block-shaped space for holding absorbent material is left in the interior of the folding pack 1.

As can further be seen from the drawings, the handle portion indicated by 3 in FIG. 1 is formed from handle portions G overlapping one another several times, six times in the embodiment illustrated, and even eight times in the rim areas at the side, so that a stable handle portion capable of load bearing is formed.

In the initial position according to FIG. 1, the folding pack 1 is filled, in accordance with a first embodiment, with a certain quantity of absorbent litter, the quantity of which is calculated in such a way that, in the state in which it is used (FIG. 4), there is a layer of litter 1 to 3 cms thick, for example, on the base area corresponding to the lower part the cat lavatory (which preferably corresponds to the areas B, W and E). In a preferred embodiment, the folding pack, or the walls W, is/are of such a height that the volume of the folding pack 1 is such that, when it is filled completely, it corresponds to a layer 2 cms deep, for example, on the total floor area of a cat lavatory formed by portions B, W and E. If so desired, the folding pack 1 can be made slightly larger, so that a certain reserve is formed, in order to make it possible for the folding pack, when folded together again after use, to hold not only the litter, but also the feces deposited by the cat.

Alternatively or in addition to the litter, a layer of non-woven material consisting of a highly absorbent and in particular odor-inhibiting material may be provided, which will likewise preferably correspond in area to the overall area formed by the floor, wall and corner portions. To this end, it can be provided for the layer of non-woven material to be folded together, in the initial state shown in FIG. 1, to a size which corresponds to the floor portion B, and which is likewise unfolded when the pack is opened into the position for use (FIG. 4).

After use, i.e. after a period of use which can be up to a week, depending on the absorptive capacity of the material used, the folding pack is folded up again together with any litter present, and can then be returned to a shape corresponding to that shown in FIG. 1, in which it can be disposed of simply, dust-free and hygienically. Since the handle and lid portions do not come into contact with litter and/or cat feces if, as is preferably the case in accordance with the invention, they were folded over the rim of a cat lavatory, the disposal process can be performed extremely hygienically.

The features disclosed in the foregoing description, in the claims and/or drawings may both separately and in any combination thereof be material for realizing the invention in diverse forms thereof.

1. A folding pack for absorbent material for use in a cat lavatory: comprising dimensionally stable container pack that can be unfolded for use and placed in a cat lavatory.

2. The folding pack as claimed in claim 1, wherein the pack is stackable.

3. The folding pack as claimed in claims 1, wherein the pack is substantially block-shaped.

4. The folding pack as claimed in claims 1, wherein the pack is made of material selected from a group consisting of blank of paper, pasteboard, paperboard, cardboard, light-weight plastic, a composite material and an absorbent material, wherein the material is flat in its initial state.

5. The folding pack as claimed in claim 1, wherein the pack has a central, preferably substantially rectangular floor portion, with preferably rectangular wall portions adjoining said floor portion.

6. The folding pack as claimed in claim 5, wherein corner portions are provided between adjacent wall portions.

7. The folding pack as claimed in claim 6, wherein the corner portions lie against said wall portions in the folded-up state, such that a substantially block-shaped space for holding absorbent material is formed.

8. The folding pack as claimed in claims 5, wherein there are lid portions adjoining wall or corner portions.

9. The folding pack as claimed in claim 5, wherein there are lid portions adjoining both the wall portions and the corner portions, such that, in the folded-up state, several of the lid portions overlap one another.

10. The folding pack as claimed in claims 8 and 9, wherein the lid portions are substantially rectangular.

11. The folding pack as claimed in claim 8, wherein there are handle portions adjacent to the lid portions.

12. The folding pack as claimed in claim 11, wherein in the folded-up state, the handle portions can be folded to lie flat on the lid portions.

13. The folding pack as claimed in claims 11 and 12, wherein the handle portions are designed to overlap several times, especially four, six or eight times.

14. The folding pack as claimed in claim 1, wherein litter is contained as absorbent material.

15. The folding pack as claimed in claim 1, wherein a layer of non-woven material is contained as absorbent material.

16. The folding pack as claimed in claim 15, wherein the layer of non-woven material comprises a highly absorbent and odor binding material.

17. The folding pack as claimed in claim 15, wherein the layer of non-woven material is joined to or integrated in the material of the folding pack.

18. The folding pack as claimed in claim 15, wherein the layer of non-woven material is between 0.1 and 1 cm thick, preferably 0.5 cm.

19. The folding pack as claimed in claim 15, wherein there is a layer of litter disposed on the layer of non-woven material.

20. The folding pack as claimed in claim 1, wherein at least one closure means for re-sealing the folding pack after use is present.

21. The folding pack as claimed in claim 20, wherein the closure means comprises adhesive tape or a string.

22. A cat lavatory comprising a lower part, which is tray-shaped, and an insert comprising an unfolded folding pack as claimed in claim 1.

23. The cat lavatory as claimed in claim 22, wherein the folding pack can be unfolded in such a way that, after it has been inserted into the lower part, its outer edge portion can be folded over an upper peripheral rim of the lower part.

24. The cat lavatory as claimed in claim 23, wherein the edge portion of the folding pack can be attached to the upper peripheral rim.

25. The cat lavatory as claimed in claim 23, further comprising an upper part which can be removably placed on the lower part in order to secure the folded-over edge portion of the folding pack on the upper peripheral rim of the lower part.

26. The cat lavatory as claimed in claim 25, wherein the upper part is designed in the form of a frame adapted to the shape of the lower part.
